(19) United States
(12) Patent Application Publication
(10) Pub. No.: US 2024/0171116 A1
(43) Pub. Date: May 23, 2024

(54) SKIP RAIL SYSTEM

(71) Applicant: PEGASUS SOLAR, INC., Richmond, CA (US)

(72) Inventors: Erich Kai Stephan, Richmond, CA (US); Glenn Harris, Sausalito, CA (US); Nicholas Wenzel, Richmond, CA (US); Peter Wilke, Richmond, CA (US)

(21) Appl. No.: 18/515,134

(22) Filed: Nov. 20, 2023

Related U.S. Application Data
(63) Continuation of application No. 16/889,635, filed on Jun. 1, 2020, now Pat. No. 11,848,636.
(60) Provisional application No. 62/857,176, filed on Jun. 4, 2019.

(51) Int. Cl. H02S 20/23; F24S 25/61; F24S 25/67

(52) U.S. Cl. CPC H02S 20/23; F24S 25/61; F24S 25/67

(57) ABSTRACT

A multi-rail system for mounting solar modules to a surface, such as a roof, uses two rails to support a first row of solar modules, and a single rail to support each subsequent row of solar modules. Splices connect edges of solar modules between rows, providing support along one edge of the solar modules for the subsequent rows.

### CROSS-REFERENCE TO RELATED APPLICATION

This application is a continuation of U.S. patent application Ser. No. 16/889,635 entitled “SKIP RAIL SYSTEM,” filed on Jun. 1, 2020, which claims the benefit of U.S. Provisional Application No. 62/857,176 entitled “SKIP RAIL SYSTEM,” filed on Jun. 4, 2019, the full disclosures of which are incorporated herein in their entirety.

### BACKGROUND

Current solar mounting solutions using rails as mounting structure require two rails per each row of solar modules. Each row takes additional time to install and increases the number of roof penetrations, which in turn increases installation labor and the risk of a roof leak. A solution which reduces the number of rows of rails is beneficial for time and cost savings along with risk reduction.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1A illustrates an isometric view of a Skip rail splice;

FIG. 1B illustrates a Skip rail splice and a solar module being installed;

FIG. 1C illustrates a Skip rail splice with a solar module installed on one side and another in process of being installed;

FIG. 1D illustrates a Skip rail splice and solar module assembly in final assembly state, side profile;

FIG. 2A illustrates an isometric view of an alternative embodiment of a Skip rail splice;

FIG. 2B illustrates an alternative embodiment of a Skip rail splice and a solar module being installed;

FIG. 2C illustrates an alternative embodiment of a Skip rail splice with a solar module installed on one side and another in process of being installed;

FIG. 2D illustrates an alternative embodiment of a Skip rail splice and solar module assembly in final assembly state, side profile;

FIG. 3 illustrates an isometric view of another alternative embodiment of a Skip rail splice; and

FIGS. 4-11 illustrate embodiments of a system of Skip rail splices.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

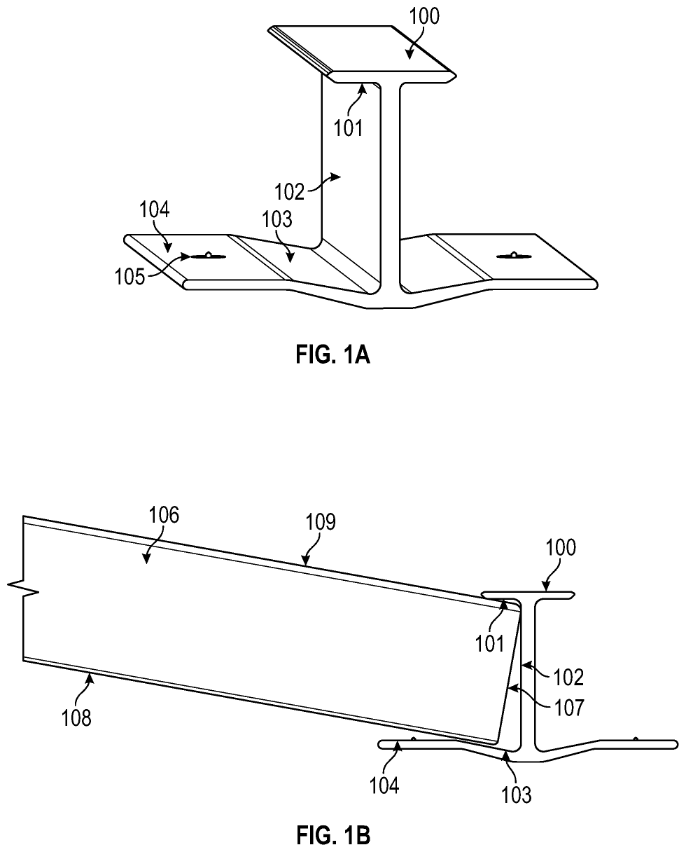

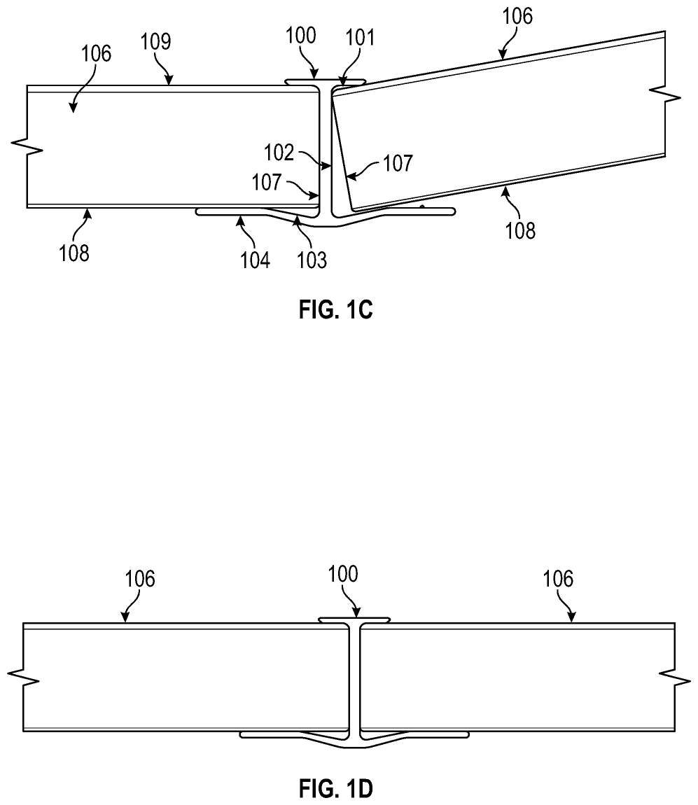

FIG. 1A depicts an isometric view of the skip rail splice 100. The skip rail splice 100 is comprised of two horizontal members 101 extending from center vertical member 102. Extending from bottom of vertical member 102 are angled members 103 which are at an angle between 0-90 degrees from the vertical member 102. The angled members 103 transition to bottom flanges 104 which may be substantially parallel to top horizontal members 101 or may be at an angle relative to top horizontal members 101. There may be one or more apertures on the face of bottom flanges 104 which may have a bond pin 105 inserted. The bond pin 105 serves the purpose of making electrical bonding connection to the solar module upon installation into the skip rail splice 100.

FIG. 1B depicts a solar module 106 being installed into a skip rail splice 100 from a side view. The solar module 106 may be inserted with the bottom edge 108 at angle relative to bottom flanges 104. The solar module 106 may then be angled down so that bottom edge 108 is substantially parallel with top horizontal member 101.

FIG. 1C depicts one solar module 106 on the left side in its final installation state where the top edge 109 of solar module 106 is in contact with top horizontal member 101. Leading edge 107 is coincident or in proximity with vertical member 102. Bottom edge 108 may be in contact with bottom flange 104. When the first solar module 106 is in the lowered position shown in FIG. 1C, the bottom flange 104 and the top horizontal member 101 may compress the frame of solar module 106 sufficiently to secure the solar module 106 from typical forces. In this example embodiment, the vertical distance between the top horizontal member 101 and the bottom flange 104 is slightly less than the vertical height of the frame of the solar module 106 in order to create a clamping force. The second solar module 106 on the right edge of skip rail splice 100 is mid-installation in substantially the same process as the left first solar module of FIG. 1B.

FIG. 1D depicts both solar modules 106 in their final install state with skip rail splice 100. In this example embodiment, the first and second solar modules 106 are substantially parallel with one another, and substantially parallel with the horizontal member 104 of the skip rail splice 100.

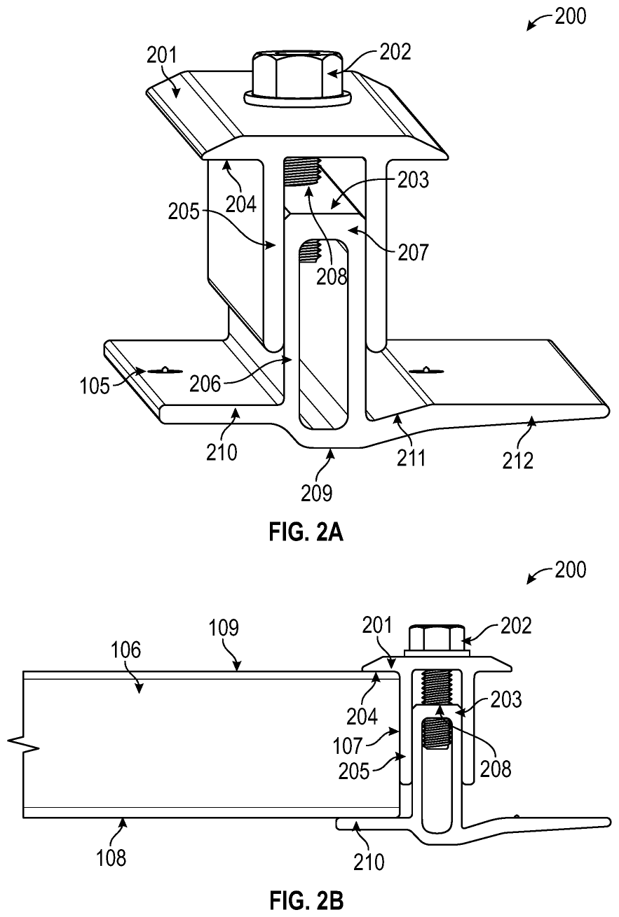

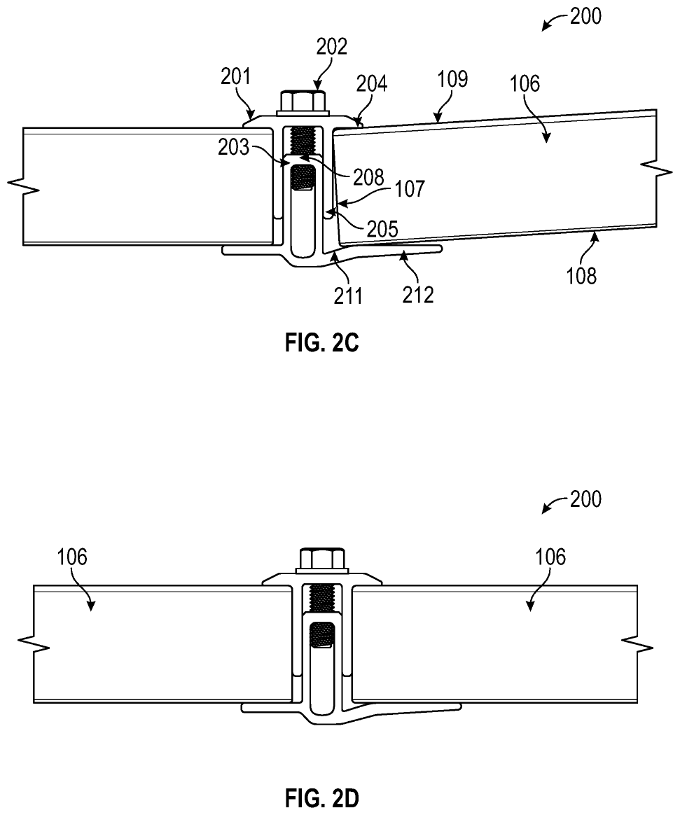

FIG. 2A depicts an isometric view of an alternative embodiment of the skip rail splice 200. The skip rail splice 200 is comprised of a top piece 201, bottom piece 203, and a fastener 202. The top piece 201 has horizontal members 204 protruding from a main body comprised of two vertical members 205 which have a “U” shape with opening at the bottom. The material between horizontal members 201 may have an aperture for fastener 202 to pass through. The bottom piece 203 of the assembly may be comprised of two vertical members 206 with a space between the two outer walls less than the width of the space between the two inner members 205 of the top piece 201. These two vertical members 206 are connected at the top by a horizontal member 207 and at the bottom with a horizontal member 209. Member 207 may have a threaded aperture 208 for receiving threaded fastener 202 which when turned, threadably tightens top piece 201 in the downward direction bringing horizontal members 204 closer to horizontal members 210 and 212 of the bottom piece 203. There may be one or more apertures on the face of horizontal members 210 and 212 which may have a bond pin 105 inserted inside said aperture. The bond pin 105 serves the purpose of making electrical bonding connection to the solar module which will be installed into the Skip rail splice 200.

FIG. 2B depicts a first solar module 106 on the left side in its final installation state where the top edge 109 of solar module 106 is in contact with horizontal member 204. Leading edge 107 is in contact with vertical member 205. Bottom edge 108 is in contact with horizontal member 210. When solar module 106 is in the position shown the fastener 202 is threadably tightened to secure or clamp the solar module between top piece 201 and bottom piece 203.

FIG. 2C depicts a solar module 106 being installed into the right side of skip rail splice 200 from a side view. The solar module 106 may be inserted with the bottom edge 108 at an angle similar to the angled member 211. Once the corner edge, between top edge 109 and leading edge 107, is positioned in contact or substantially close with vertical member 205, the solar module 106 may be angled down into its final install state shown in FIG. 2D.

FIG. 2D depicts both solar modules 106 in their final install state with skip rail splice 200.

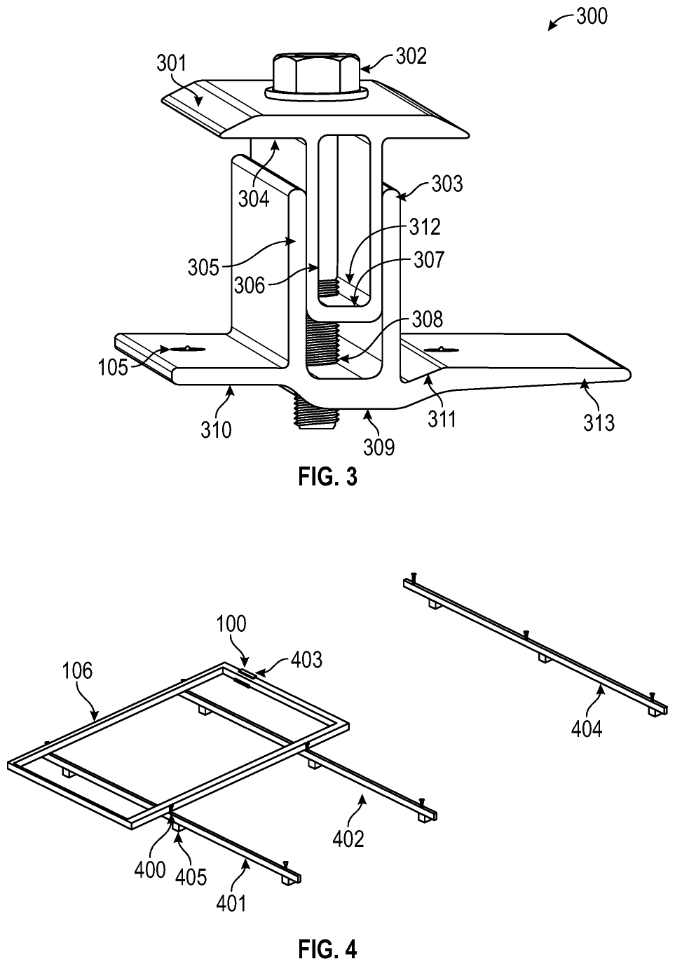

FIG. 3 depicts an isometric view of an alternative embodiment of the skip rail splice 300. The skip rail splice 300 is comprised of a top piece 301, bottom piece 303, and a fastener 302. The top piece 301 has horizontal members 304 protruding from a main body comprised of two vertical members 306 and third member 307 connecting the two. The bottom member 307 may have an aperture 312 for fastener 302 to pass through. The bottom piece 303 of the assembly may be comprised of two vertical members 305 with a space between the two inner walls greater than the width of the two outer members 306 of the top piece 301. These two vertical members 305 are connected by a third member 309, creating a “U” shape. The third member 309 may have a threaded aperture for receiving threaded fastener 302 which when turned, threadably tightens or clamps top piece 301 in the downward direction bringing horizontal members 304 closer to horizontal members 310 and 313 of the bottom piece 303. There may be one or more apertures on the face of horizontal members 310 and 313 which may have a bond pin 105 inserted inside said aperture. The bond pin 105 serves the purpose of making electrical bonding connection to the solar module which will be installed into the skip rail splice 300.

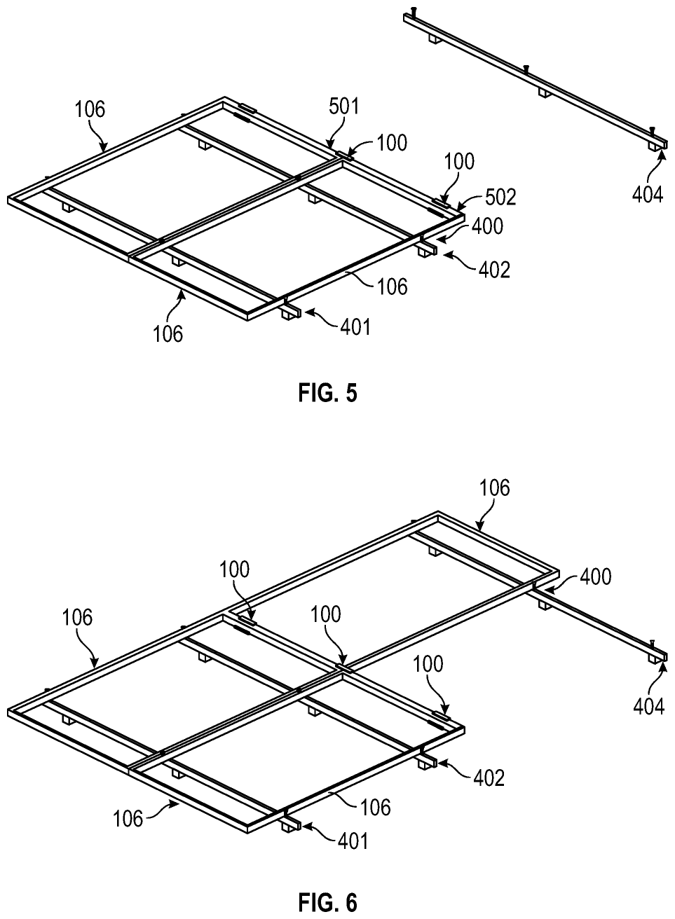

FIGS. 4 through 11 show installation examples of a system of skip rail splices 100. These example systems are possible with the example embodiments shown in FIGS. 1 through 3. Typical solar installation systems require two rows of rails per row of solar modules 106, but in utilizing a skip rail splice 100, the array of solar modules often only requires one row of rails for solar module rows two and above within a solar array.

FIG. 4 is an example embodiment of the present invention depicting a solar module 106 installed in a portrait orientation on a first rail 401 and a second rail 402. The first rail 401, second rail 402, and third rail 404 are all attached to a roof surface using a mount 405. The solar module 106 is secured to the first rail 401 and second rail 402 by clamps 400 at each of the four locations where the frame of the solar module 106 contacts the rails. A first skip rail splice 100 is positioned at row-end splice location 403. In this example embodiment, a first rail 401 is positioned within the first half of a solar module 106, and the second rail 402 is positioned substantially parallel with the first rail 401 in the second half of solar module 106. For a second row of solar modules (not shown), a third rail 404 is positioned substantially parallel to the first two rails, in a position that would align in the farthest half of a to-be-installed solar module above the first solar module 106. In this example embodiment, there is no rail positioned in the lower half of a solar module in the second row of the array.

FIG. 5 depicts a possible next step in the installation of the array of solar modules 106. One or more solar modules 106 are attached in the same row as the first solar module 106 to rails 401 and 402. On the top edge of the solar modules 106, a skip rail splice 100 is attached. One or more skip rail splices 100 are attached per solar module 106 along length of top edge and there may be a skip rail splice 100 that is attached to two solar modules 106 at mid-row splice location 501. A third skip rail splice 100 is located at the right edge of a right-end splice location 502. In other example embodiments, a row of solar modules 106 may have a skip rail splice 100 at multiple mid-row splice locations 501.

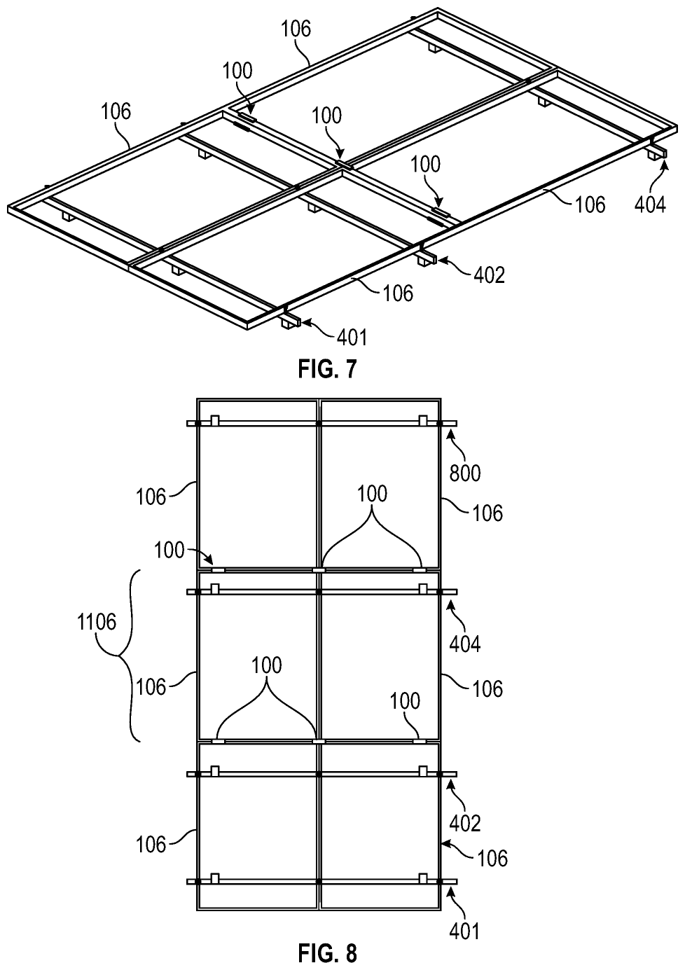

FIG. 6 depicts a possible next step in the installation of the array of solar modules 106. A solar module 106 is installed above first row of solar modules 106. The bottom edge of the solar module 106 is installed into the top edge of one or more skip rail splices 100 which were installed on top edge of solar modules in the previous step shown in FIG. 5. The example method of installing solar module 106 into skip rail splice 100 can be seen in the depiction in FIGS. 1C-1D and FIGS. 2C-2D. Next, the sides of the frame on module 106 are secured to the third rail 404 with clamp(s) 400.

FIG. 7 depicts a possible next step in the installation of the array of solar modules 106. One or more solar modules 106 are installed in the second row next to the first solar modules 106 shown in FIG. 6. These solar modules 106 are installed in substantially the same process as described in previous steps, including the example method depicted in FIGS. 1C-1D and FIGS. 2C-2D. The bottom edge of the solar module 106 may install into the top edge of a skip rail splice 100 shared with a module in the same row immediately to the left or right. If the solar module 106 is the outermost solar module of the row in the array, it may be the only solar module 106 installed into the top edge of a skip rail splice 100 located in an end splice location 502.

FIG. 8 depicts an example embodiment from an overhead view showing a solar module array with three rows of 2 solar modules each. In this example embodiment of the present invention, the three rows of solar modules 106 employ 4 rows for rails and two rows of skip rail splices 100. In this example embodiment, a first rail 401 is positioned within the first half of a solar module 106, and the second rail 402 is positioned substantially parallel with the first rail 401 in the second half of the same solar module 106. For a second row of solar modules 106, a third rail 404 is positioned substantially parallel to the first two rails, in a position that aligns it in the farthest half of the second row of solar modules 106 above the first row of solar modules 106. In this example embodiment, there is no rail positioned in the lower half of the solar modules 106 in the second row of the array. A fourth rail 800 is positioned substantially parallel to the first three rails, in a position that would align in the farthest half of the third row of solar modules 106. In this example embodiment, there is no rail positioned in the lower half of the solar modules 106 in the third row of the array. As depicted, the spacing between the second rail 402 and the third rail 404, and the spacing between the third rail 404 and the fourth rail 800, generally correspond to the length of the longer edge 1106 of the second row of solar modules.

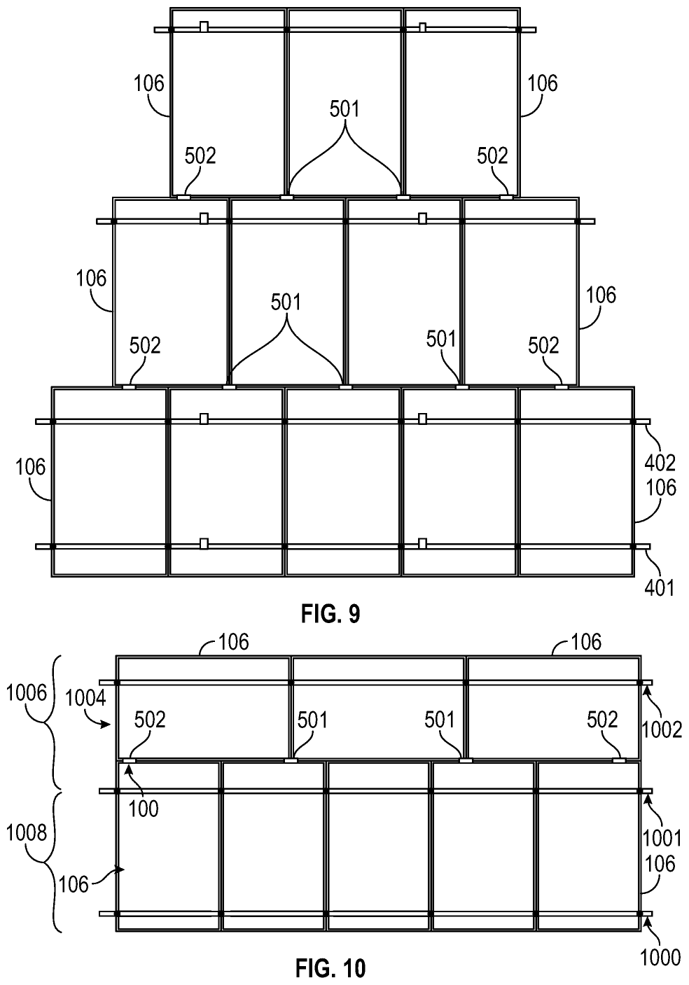

FIG. 9 depicts an example embodiment of an array of solar modules 106 with different numbers of solar modules 106 in the different rows of the array. Between each of the rows of solar modules 106 there is a row of skip rail spices 100 which may have two skip rail splices 100 in row-end splice locations 502 and multiple skip rail splices 100 in mid-row splice locations 501. Each of these skip rail splices 100 may attach to two, three, or four solar modules 106. As depicted, the skip rail splices 100 that are positioned in mid-row splice locations 501 are positioned to connect one solar module 106 in the solar module row below the skip rail splice 100 and two solar modules 106 in the solar module row above the skip rail splice 100. Skip rail splices 100 that are positioned in row-end splice locations 502 connect one solar module 106 from the row above and one solar module 106 from the row below skip rail splice 100. FIG. 9 depicts an example embodiment of an array of solar modules where alignment of the modules alternates from one row to the next, and the number of modules in each row decreases for each added row.

FIG. 10 depicts an example embodiment of an array of solar modules of mixed landscape 1006 and portrait 1008 orientations. Between the rows of solar modules 106 there is a row of skip rail spices 100 which may have two skip rail splices 100 in row-end splice locations 502 and multiple skip rail splices 100 in mid-row splice locations 501. Each of these skip rail splices 100 may attach to two, three, or four solar modules 106. In this example embodiment, a first rail 1000 is positioned within the first half of a solar module 106, and the second rail 1001 is positioned substantially parallel with the first rail 1000 in the second half of solar module 106. For the second row of solar modules 106 in landscape 1006 orientation, a third rail 1002 is positioned substantially parallel to the first two rails, in a position that aligns it in the farthest half of the edge of a row of solar modules 106 above the first row of solar modules 106. In this example embodiment, there is no rail positioned in the lower half of the solar modules 106 in the second row of the array. The spacing between the second rail 1001 and the third rail 1002 generally corresponds to the length of the shorter edge 1004 of the second row of solar modules. As depicted, the skip rail splices 100 that are positioned in mid-row splice locations 501 are positioned to connect one solar module 106 in the solar module row below the skip rail splice 100 and two solar modules 106 in the solar module row above the skip rail splice 100. Skip rail splices 100 that are positioned in row-end splice locations 502 connect one solar module 106 from the row above and one solar module 106 from the row below skip rail splice 100.

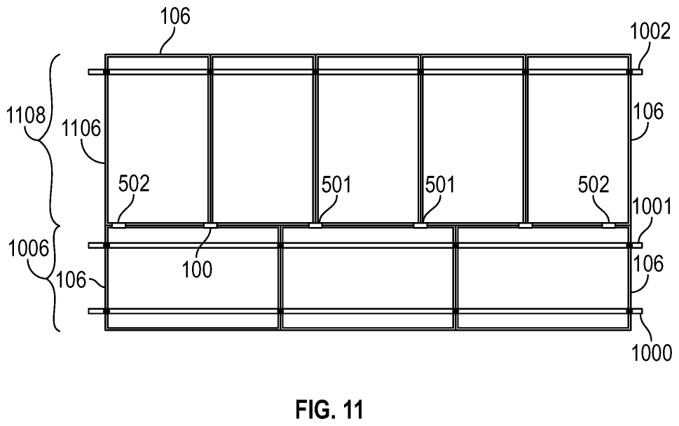

FIG. 11 depicts an example embodiment of an array of solar modules of mixed landscape 1006 and portrait 1108 orientations. Between the rows of solar modules 106 there is a row of skip rail spices 100 which may have two skip rail splices 100 in row-end splice locations 502 and multiple skip rail splices 100 in mid-row splice locations 501. Each of these skip rail splices 100 may attach to two, three, or four solar modules 106. In this example embodiment, a first rail 1000 is positioned within the first half of a solar module 106, and the second rail 1001 is positioned substantially parallel with the first rail 1000 in the second half of solar module 106. For the second row of solar modules 106 in portrait 1108 orientation, a third rail 1002 is positioned substantially parallel to the first two rails, in a position that aligns it in the farthest half of the edge of a row of solar modules 106 above the first row of solar modules 106. In this example embodiment, there is no rail positioned in the lower half of the solar modules 106 in the second row of the array. The spacing between the second rail 1001 and the third rail 1002 generally corresponds to the length of the longer edge 1106 of the second row of solar modules. As depicted, the skip rail splices 100 that are positioned in mid-row splice locations 501 are positioned to connect one solar module 106 in the solar module row below the skip rail splice 100 and two solar modules 106 in the solar module row above the skip rail splice 100. Skip rail splices 100 that are positioned in row-end splice locations 502 connect one solar module 106 from the row above and one solar module 106 from the row below skip rail splice 100.

Unless specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. (canceled)

2. A mounting system for solar modules, the system comprising:
a pair of mounting rails configured to support a first solar module when a first mounting rail of the pair is positioned under a first half of the first solar module and a second mounting rail of the pair is positioned under a second half of the first solar module, wherein the first solar module has a top edge and a bottom edge opposite the top edge;
a third mounting rail configured to support a second solar module when the third mounting rail is positioned under the second solar module, wherein the second solar module has a top edge and a bottom edge opposite the top edge; and
a skip rail splice configured to connect the top edge of the first solar module to the bottom edge of the second solar module, wherein the skip rail splice is positioned between the second mounting rail and third mounting rail.

3. The mounting system of claim 2, wherein the third mounting rail is configured to extend under a second half of the second solar module between the top edge and the bottom edge of the second solar module.

4. The mounting system of claim 2, further comprising one or more mounts configured to attach the pair of mounting rails and the third mounting rail to a roof surface.

5. The mounting system of claim 2, further comprising one or more clamps configured to attach the first solar module to the first mounting rail.

6. The mounting system of claim 2, wherein the skip rail splice includes a top edge configured to connect to both the second solar module and a third solar module in a same row of solar modules.

7. The mounting system of claim 2, wherein the top edge of the first solar module and the top edge of the second solar module are parallel to the pair of mounting rails.

8. The mounting system of claim 2, wherein a length of the top edge of the first solar module is different than a length of the top edge of the second solar module.

9. A mounting system for solar modules, the system comprising:
a pair of mounting rails configured to support a plurality of solar modules in a first row, wherein a first mounting rail of the pair is positioned under a first half of each of the solar modules in the first row, and wherein a second mounting rail of the pair is positioned under a second half of each of the solar modules in the first row;
a third mounting rail configured to support a second row of solar modules, wherein the third mounting rail is positioned under a second half of each of the solar modules in the second row; and
a skip rail splice configured to connect a top edge of a first solar module in the first row to a bottom edge of a first solar module in the second row.

10. The mounting system of claim 9, wherein the first mounting rail is parallel to the second mounting rail, and wherein the second mounting rail is further parallel to the third mounting rail.

11. The mounting system of claim 9, wherein the first mounting rail, the second mounting rail, and the third mounting rail are parallel to a bottom edge of the first row of solar modules.

12. The mounting system of claim 9, wherein the skip rail splice is further configured to connect two solar modules in the first row to two solar modules in the second row.

13. The mounting system of claim 9, wherein the skip rail splice is further configured to connect one solar module in the first row to two solar modules in the second row.

14. The mounting system of claim 9, further comprising one or more clamps configured to attach a solar module in the first row to one or more of the first mounting rail and the second mounting rail.

15. The mounting system of claim 9, further comprising one or more mounts configured to attach one or more of the first mounting rail, the second mounting rail, and the third mounting rail to a roof surface.

16. The mounting system of claim 9, wherein the solar modules in the first row are arranged in portrait orientation along the pair of mounting rails, and wherein the solar modules in the second row are arranged in portrait orientation along the third mounting rail.

17. The mounting system of claim 9, wherein the solar modules in the first row are arranged in landscape orientation along the pair of mounting rails, and wherein the solar modules in the second row are arranged in landscape orientation along the third mounting rail.

18. The mounting system of claim 9, wherein the solar modules in the first row are arranged in portrait orientation along the pair of mounting rails, and wherein the solar modules in the second row are in landscape orientation along the third mounting rail.

19. The mounting system of claim 9, wherein the first solar module and the second solar module connected by the skip rail splice are respectively at an end of the first row and the second row, and further comprising a second skip rail splice configured to connect a top edge of a third solar module in the first row to a bottom edge of a fourth solar module in the second row, wherein the third solar module and the fourth solar module are respective in a middle of the first row and the second row.

20. A method for installing solar modules using a mounting system, the method comprising:
attaching a pair of mounting rails including a first mounting rail and a second mounting to an installation surface using a plurality of mounts;
attaching a third mounting rail to the installation surface;
attaching a first row of solar modules to the first mounting rail and the second mounting rail of the pair using one or more clamps, wherein the first mounting rail is positioned under a first half of each of the solar modules in the first row and the second mounting rail is positioned under a second half of each of the solar modules in the first row;
attaching a skip rail splice to a top edge of a first solar module in the first row;
installing a bottom edge of a first solar module in a second row to the skip rail splice; and
attaching the solar modules in the second row to the third mounting rail, wherein the third mounting rail is positioned under a further half of a second solar module in the second row relative to the first row.

21. The method of claim 20, wherein the solar modules in the first row and the solar modules in the second row are arranged in portrait orientation respectively along the pair of mounting rails and the third mounting rail.

22. The method of claim 20, wherein the solar modules in the first row and the solar modules in the second row are arranged in landscape orientation respectively along the pair of mounting rails and the third mounting rail.

23. The method of claim 20, wherein the solar modules in the first row are arranged in portrait orientation along the pair of mounting rails, and wherein the solar modules in the second row are in landscape orientation along the third mounting rail.

24. The method of claim 20, wherein the first solar module and the second solar module connected by the skip rail splice are respectively at an end of the first row and the second row, and further comprising using a second skip rail splice to connect a top edge of a third solar module in the first row to a bottom edge of a fourth solar module in the second row, wherein the third solar module and the fourth solar module are respective in a middle of the first row and the second row.

25. A method for installing solar modules using a mounting system, the method comprising:
attaching a pair of mounting rails including a first mounting rail and a second mounting rail to an installation surface using a plurality of mounts, wherein the first mounting rail is configured to support a first half of solar modules in a first row, and wherein the second mounting rail is configured to support a second half of the solar modules in the first row;
attaching a third mounting rail to the installation surface, wherein the third mounting rail is configured to support a second row of solar modules;
attaching the first row of solar modules to the first mounting rail and the second mounting rail using one or more clamps;
attaching two or more skip rail splices to a top edge of a first solar module in the first row;
installing a bottom edge of a first solar module in the second row to the two or more skip rail splices; and
attaching the second row of solar modules onto the third mounting rail.

26. The method of claim 25, wherein the solar modules in the first row and the solar modules in the second row are arranged in portrait orientation respectively along the pair of mounting rails and the third mounting rail.

27. The method of claim 25, wherein the solar modules in the first row and the solar modules in the second row are arranged in landscape orientation respectively along the pair of mounting rails and the third mounting rail.

28. The method of claim 25, wherein the solar modules in the first row are arranged in portrait orientation along the pair of mounting rails, and wherein the solar modules in the second row are in landscape orientation along the third mounting rail.

29. The method of claim 25, wherein the first solar module and the second solar module connected by one of the skip rail splices are respectively at an end of the first row and the second row, and further comprising using at least a second skip rail splice to connect a top edge of a third solar module in the first row to a bottom edge of a fourth solar module in the second row, wherein the third solar module and the fourth solar module are respective in a middle of the first row and the second row.
